(19) United States
(12) Patent Application Publication
(10) Pub. No.: US 2018/0189821 A1
(43) Pub. Date: Jul. 5, 2018

(54) EVALUATING CONTENT PLACEMENT OPTIONS AGAINST BENCHMARK PLACEMENTS

(71) Applicant: Facebook, Inc., Menlo Park, CA (US)

(72) Inventors: Robert Daniel Paul Masson, Seattle, WA (US); Huifang Yin, Bellevue, WA (US)

(21) Appl. No.: 15/396,150

(22) Filed: Dec. 30, 2016

(51) Int. Cl. G06Q 30/02

(52) U.S. Cl. CPC G06Q 30/0243; G06Q 30/0246

(57) ABSTRACT

An online system evaluates the efficacy of one or more content placement slots within a content publisher in a publisher's page layout. To evaluate the efficacy of the content slot, the conversion rate at the slot and in a benchmark for selected content items published at the slot is identified to determine the ratio of conversions at the publisher slot and in the benchmark. For different content items, these conversion ratios may vary, and may further be weighed by a value contribution for each content item. Thus, to determine the value of the conversion ratios for a given publisher, the online system uses information about online system users and their interactions with third party content featured within different locations, or placements, within the publisher's page layout. The arrangement of slots in relation to one another can be manipulated by the publisher to yield optimal conversion rates for featured slots. For example, the publisher may reposition slots within a given page, or relocate slots to other pages, in order to increase conversion rates.

### BACKGROUND

This invention relates generally to evaluating the effectiveness of placing content into content slots within a publisher, and particularly to evaluating the efficacy of a publisher's content slot against a benchmark placement location.

Publishers provide content for users to consume in an interactive system. Such interactive systems may be websites, games, applications or other electronic interactive systems of interest to a user. When providing the content to users, the publisher may develop a layout or other interactive flow in which the user interacts with the publisher. Within the layout, the publisher may provide one or more slots for content selected by another system or for placement of sponsored content. For example, an application may include an interstitial slot for placement of content between portions of the interactive publisher's content.

Publishers generally can select and control the location of these content slots, which may impact a user's likely interaction with the content selected for and placed in the slot. Typically the user's interaction with the content placed in the slot is beneficial for the publisher, for example to encourage a user to take a behavior related to the content selected for the slot. The behavior may directly or indirectly benefit the publisher. For example sponsored content may be selected for the slot. Depending on where the slot is placed within the layout of the interactive system, users of the interactive system may be more or less likely to interact with the content. However, publishers typically have lacked the tools to evaluate the efficacy of these placements, particularly because different content selected for the slot may also have different interaction rates in the interactive system relative to other locations at which the selected content is shown (for example, at other interactive systems). In addition, ineffective slots selected by a publisher may often reflect positioning of a slot that detracts from or reduces user interaction with the publisher as a whole, reducing the quality of user experience with the publisher as a whole.

### SUMMARY

An online system evaluates the efficacy of the content slots placed within a publisher's layout. The efficacy of placing content in a particular slot can be evaluated relative to placements of the content in the slot compared to the same placements in a benchmark system. For each content item to be placed in the slot, the content is associated with a conversion action representing the desired behavior of a user after being presented with the content. Thus, the conversion action is an objective of the content, and may be the user clicking on or interacting with the content or may be a user installing a program or application related to the content, exploring products available for purchase and so forth. To evaluate the efficacy of the content slot, the conversion rate at the slot and in the benchmark for each selected content item is identified to determine the ratio of conversions at the publisher slot and in the benchmark. Thus a given content item when presented in the slot may have a conversion ratio of 110% or 90% of the conversion rate when presented in the benchmark, for example. Across different content items, these conversion ratios may vary. In addition, some content may be more effective than other content at generating revenue or other desired value for the publisher when the content is selected for display. The conversion ratios may be weighed according to the value to the publisher associated with each placed content item. By combining the conversion ratios for content items placed at the slot, the efficacy of displaying the content item to users at a given slot may be determined. This efficacy may permit publishers to develop and control slot placements to improve the efficacy of the slot relative to the benchmark, and provide an evaluation of the slot that is independent of variations in third party value over time. In addition, because each advertisement may consider a conversion differently, the score may account for different ways in which advertisers view success (i.e., the different conversion events for sponsored content), which may differ.

The online system may also analyze each slot in a publisher's layout to determine the efficacy of the slots within the publisher's layout. For example, a publisher may arrange a set of slots within an application. To determine the value of the conversion ratios for a given publisher across a layout for the publisher as a whole, the online system uses information about online system users and their interactions with third party content featured within the different locations of slots within the publisher's page layout. By evaluating the slots with respect to performance on the benchmark placements and for the content items placed at the slots, the arrangement of slots in relation to one another can be manipulated by the publisher to yield optimal conversion rates for content slots. For example, the publisher may re-position slots within a given page, remove underperforming slots, or relocate slots to other pages, to increase the efficacy of slots at the publisher and avoid slots that diminish user interactions.

### BRIEF DESCRIPTION OF THE DRAWINGS

FIG. 1 is a block diagram of a system environment for evaluating content placement options against benchmark placements according to one embodiment.

FIG. 2 is a block diagram of an online system having a performance outcome score generator according to one embodiment.

FIG. 3A is a block diagram of an example content publisher according to one embodiment.

FIG. 3B is a block diagram of a benchmark publisher according to one embodiment.

FIG. 4 is a table illustrating an example performance outcome score according to one embodiment.

FIG. 5A is a block diagram illustrating the page layout flow of sponsored content slots within an example content publisher according to one embodiment.

FIG. 5B is a block diagram illustrating an alternate page layout flow of sponsored content slots within an example content publisher according to one embodiment.

FIG. 6 is a flowchart illustrating a process for generating a performance outcome score for a given sponsored content slot according to one embodiment.

FIG. 7 is a flowchart illustrating a process for providing sponsored content to users of a content publisher according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

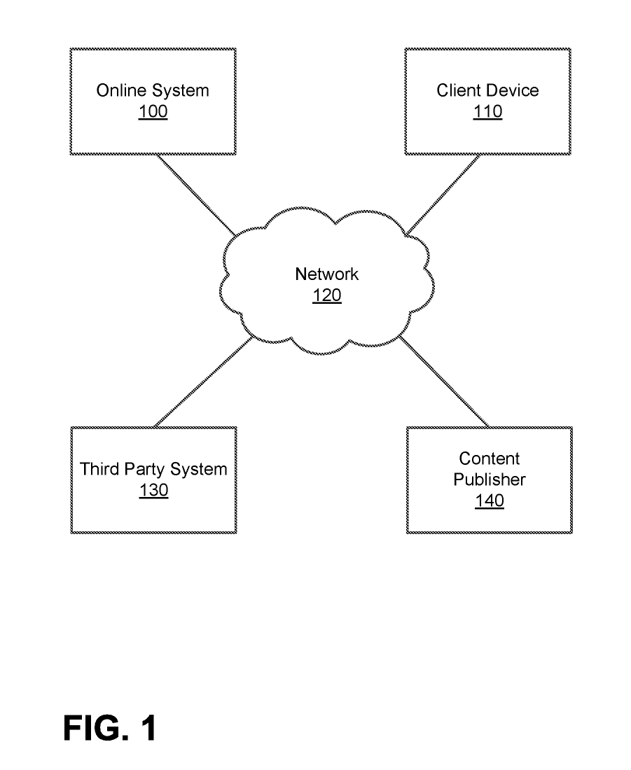

FIG. 1 is a block diagram of a system environment for generating and providing performance outcome scores to content publishers. The system environment includes an online system 100, a client device 110, a network 120, one or more third party systems 130, and a content publisher 140. In other embodiments, different and/or additional entities can be included in the system architecture. The online system 100 provides content items, such as sponsored content items, to users of the client devices 110 accessing the content publisher 140 or an application controlled by the content publisher 140. Sponsored content items are also provided to users by other publishing platforms, one of which may be considered a benchmark for the sponsored content item. The online system 100 evaluates performance of the content items in slots of the content publisher 140 in comparison to the benchmark publishing platform to determine the comparative performance of the content publisher's slots in promoting the content items and associated interactions with the content items. As the evaluation may be performed with respect to individual slots in which content items can be provided, the content publisher 140 may use the performance of slots to adjust where and when slots are provided by the publisher to increase the comparative performance of a publisher's slots. In addition, the comparative performance of a publisher's slot may also reflect poor presentation of content in the slot, and the online system 100 may also use the comparative scores to modify what content items may be presented in the publisher's slot.

The online system 100 includes a computing environment that allows users of the online system 100 to communicate or otherwise interact with each other and access content. The online system 100 stores information about the users, for example, user profile information and information about actions performed by users on the online system 100. The online system 100 maintains content items for presentation to users via publication platforms, such as the content publisher 140 or via another publication channel, which may be operated by the online system 100. When an available slot is identified, the online system selects a content item for presentation in the available slot from various content items that may be presented to users. As users interact with the content publisher 140 (or an application provided by the content publisher), the online system 100 provides content items for available slots. The selected content items may be provided by third party systems 130 and may include a value to a third party system 130 when an action is performed by a user responsive to the selection of the content item. The online system 100 may select from among these content items based on the value associated with each content item.

The client device 110 is a computing device capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 100. For example, a client device 110 executes a browser application to enable interaction between the client device 110 and the online system 100 via the network 120. In another embodiment, a client device 110 interacts with the online system 100 through an application programming interface (API) running on a native operating system of the client device 110, such as IOS® or ANDROID™. The client device 110 may interact with the content publisher 140 to view and retrieve content from the content publisher 140. In some embodiments, the client device 110 retrieves and executes an application provided by the content publisher 140. Within the application (or while the client device 110 accesses content at the third party system 130), content slots may be specified for which content is retrieved from the online system 100. The content slots may be located within the content of the content publisher 140 according to a layout specified by the content publisher 140. When content items are retrieved from the online system 100, users may interact with the retrieved content items, for example to access a related page or perform another interaction associated with the selected content item.

One or more third party systems 130 may be coupled to the network 120 for communicating with the online system 100. The third party systems 130 provide content items to the online system 100 for selection and presentation to users of the client devices 110. The content items may describe applications for execution by a client device 110 or other content for a user to interact with. The third party system 130 may provide the content items as sponsored content that encourages a user's action based on placement of the content item to a user, and may also provide a value to the online system and/or content publisher 140 when the content item is provided to the user or when the user performed the designated action. For example, the third party system 130 may provide information about products or services provided by the third party system that may be of interest to users. When users express an interest in or interact with the content, the third party system 130 may provide value to the online system 100 or the content publisher 140 for providing the content to users. Thus, the third party system 130 may represent a company offering a product, service, or message that the company wishes to promote to users of the client devices 110.

The network 120 includes any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The content publisher 140 provides content accessed by users of the client device 110 and provides slots in which content items selected by the online system 100 are placed. In one embodiment, a content publisher 140 is an application provider that provides an application for execution by a client device 110 or communicating data to client devices 110 for use by an application executing on the client device 110. In other embodiments, a content publisher 140 provides content (e.g., videos, pictures, news stories, and other content) or other information for presentation via a client device 110.

The content publisher 140 features locations within a page layout where one or more content items can be presented to a user from the online system 100. These content items may be sponsored by the third party systems 130 to provide value to the content publisher 140. Sponsored content items can be placed within sponsored content slots arranged vertically or horizontally in different portions of a page layout according to the preferences of a content publisher 140. In one embodiment, locations within a page layout designated for sponsored content are segmented into a number of sponsored content slots arranged according to the dimensions of the sponsored content provided by a third party system 130. This sponsored content is selected by the online system 100 for presentation on a client device 110 at a content publisher 140's page or within a content publisher's application executing on client device 110. The online system 100 may evaluate the efficacy of content slot by determining a performance outcome score for a content slot.

### II. Online System

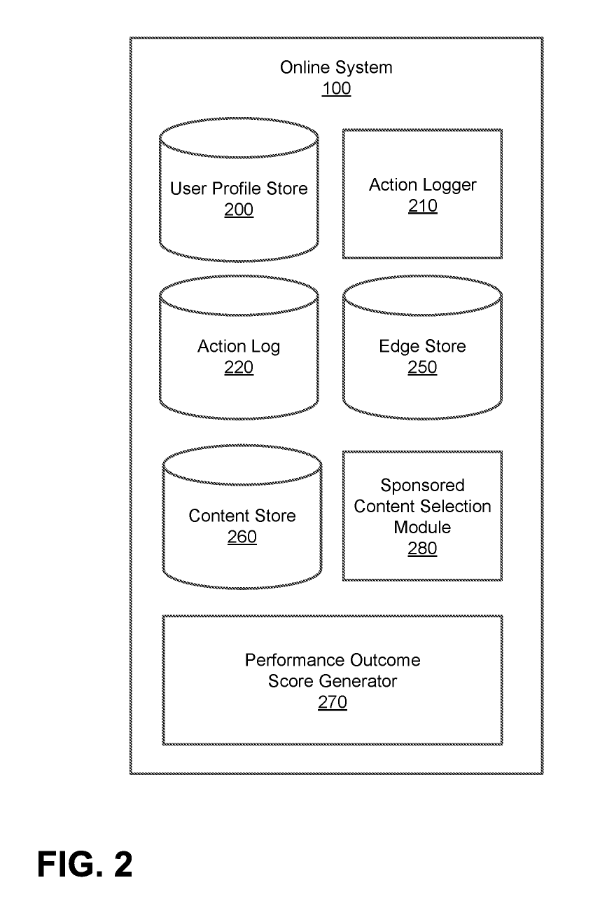

FIG. 2 is a block diagram of an online system 100 with a performance outcome score generator 270 according to one embodiment. In the embodiment illustrated in FIG. 2, the online system 100 includes a user profile store 200, an action logger 210, an action log 220, an edge store 250, a content store 260, a sponsored content selection module 280, and a performance outcome score generator 270. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

Each user of the online system 100 is associated with a user profile, which is stored in the user profile store 200. A user profile includes declarative information about the user that was explicitly shared by the user and may also include profile information inferred by the online system 100. In one embodiment, a user profile store 200 of an online system user includes multiple data fields, each describing one or more attributes of the user. Examples of information stored in a user profile store 200 include biographic, demographic, and other types of descriptive information, such as work experience, educational history, gender, hobbies or preferences, location and the like. A user profile may also store other information provided by the user, for example, images or videos. In certain embodiments, an image of a user may be tagged with information identifying the online system user displayed in an image. A user profile in the user profile store 200 may also maintain references to actions by the corresponding user performed on content items in the action log 220.

While user profiles in the user profile store 200 are frequently associated with individuals, allowing individuals to interact with each other via the online system 100, user profiles may also be stored for entities such as businesses or organizations. This allows an entity to establish a presence on the online system 100 for connecting and exchanging content with other online system 100 users. The entity may post information about itself, about its products or provide other information to users of the online system 100 using a brand page associated with the entity's user profile. Other users of the online system 100 may connect to the brand page to receive information posted to the brand page or to receive information from the brand page. A user profile associated with the brand page may include information about the entity itself, providing users with background or informational data about the entity.

The action logger 210 receives communications about user actions internal to and/or external to the online system 100, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 100 to track user actions on the online system 100, as well as actions on third party systems 130 that communicate information to the online system 100. Users may interact with various objects on the online system 100, and information describing these interactions is stored in the action log 220. Examples of interactions with objects include: viewing videos, commenting on posts, sharing links, checking-in to physical locations via a mobile device, accessing content items, and any other suitable interactions. Additional examples of interactions with objects on the online system 100 that are included in the action log 220 include: viewing videos posted by a user's connections in the online system 100, commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with sponsored content on the online system 100 as well as with other applications operating on the online system 100. In some embodiments, data from the action log 220 is used to infer interests or preferences of a user, augmenting the interests included in the user's user profile store 200 and allowing a more complete understanding of user preferences.

In one embodiment, the edge store 250 stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. In one embodiment, the user profile store 200 stores data describing the connections between different users of the online system 100, such as the number of friends shared between the users out of the total number of friends, the fraction of time since joining or becoming a member of the social networking system that overlaps between the two users (e.g., whether the users joined the online system at the same time or have an overlap for a certain period of time), or a combination of these signals. The record of users and their connections in the online system 100 may be called a “social graph.”

Other edges are generated when users interact with objects in the online system 100, such as expressing interest in a page on the online system 100, sharing a link with other users of the online system 100, viewing videos posted by other users of the online system 100, and commenting on posts or videos provided by other users of the online system 100. The connections between users and other objects, or edges, can be unidirectional (e.g., a user following another user) or bidirectional (e.g., a user is a friend with another user).

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 100, or information describing demographic information about a user. Each feature may be associated with a source object or user, a target object or user, and a feature value. A feature may be specified as an expression based on values describing the source object or user, the target object or user, or interactions between the source object or user and target object or user. Hence, an edge may be represented as one or more feature expressions.

The edge store 250 also stores information about edges, such as affinity scores for objects, interests, and other users. In one embodiment, affinity scores, or “affinities,” are computed by the online system 100 over time to approximate a user's interest in an object or another user in the online system 100 based on the actions performed by the user. A user's affinity may be computed by the online system 100 over time to approximate a user's affinity for an object, interest, and other users in the online system 100 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 250, in one embodiment. Alternatively, each interaction between a user and a specific object is stored as a separate edge.

The content store 260 stores objects that represent various types of content. Examples of content represented by an object include a video, page post, status update, photograph, link, shared content item, gaming application achievement, check-in event at a local business, brand page, or any other type of content. Online system 100 users may create objects stored by the content store 260, such as status updates, photos tagged by users to be associated with other objects in the online system 100, events, groups, or applications. In some embodiments, objects are received from third party systems 130 and placed in the content store 260. These objects may represent sponsored content campaigns provided by one or more third party systems 130. In one embodiment, received information associated with sponsored content campaigns includes criteria regarding how and when the sponsored content is to be used by the online system 100, which may include a threshold performance metric for sponsored content slots within a content publisher 140. Thus, the sponsored content may specify a minimum performance outcome score for a slot in which the sponsored content is presented. As discussed below, the performance outcome score may specify the comparative likelihood of users to interact with a sponsored content slot relative to a benchmark slot. The performance outcome score may also reflect user experiences at the different placement locations. By setting a threshold performance score, the third party may limit presentation of the advertisement to avoid slots that present poor user experiences.

The sponsored content may also specify information about selecting the sponsored content, such as an amount for the sponsored content to bid on placements of the sponsored content in an auction, or a budget for a campaign associated with the sponsored content. The sponsored content may also specify parameters or conditions for providing the content to users. The sponsored content may also specify one or more actions performed by a user that is desired by the third party provider for the sponsored content. In this way, the desired action is a measurable objective of the sponsored content. The desired action is termed a conversion or a conversion event. The conversion event may be the user interacting with the content, for example by “clicking” or selecting the content to view a page or other item referenced by the sponsored content. In other examples the conversion event may be downloading or installing an application associated with the sponsored content, while another conversion event may be installing the application and further purchasing or interacting with the application. In other examples, the conversion event may be completing a purchase on a website. These conversion events may be specified for each sponsored content by the third party that provided the sponsored content item. In some examples, the online system receives a value or contribution amount from the third party for placing a sponsored content item when the conversion event occurs.

In other examples, a conversion event for the sponsored content item may be automatically determined based on the type of sponsored content, which may not be the basis on which the online system receives value for presenting the sponsored content. In this example, the online system 100 may identify or determine an objective (e.g., conversion event) for an advertisement to reflect the likely desired objective of the advertisement. For example, a sponsored content item relating to an installation of an application may be associated with a conversion event for installing the application. As another example, for a sponsored content item relating to an installation of an application that reports application events to the online system, the online system 100 may identify a conversion event related to receipt of specified events from the application indicating that a user both installed and interacted with the application. These interactions may include a validation of the application, a purchase event in the application, or an event in the application indicating interaction with the application beyond installing the application. The conversion events for a sponsored content item may be stored and identified in the action log 220 or the edge store 250.

The sponsored content selection module 280 selects sponsored content items to be presented to an online system 100 user. The selected content may be provided to the user when the user accesses the online system 100, for example to view content of the online system 100, or may be provided to the user when the user accesses the content publisher 140 or interacts with a content publisher's application. When the online system 100 or a content publisher 140 (or the content publisher's application on the device) has a location (or slot) in which sponsored content may be placed by the online system 100, the sponsored content selection module 280 receives a request to select content for the location and provides the selected content item for display in that location. In one embodiment, the sponsored content selection module 280 selects sponsored content items from the available sponsored content campaigns stored in the content store 260. In other embodiments, the sponsored content selection module 280 selects sponsored content item from available sponsored content campaigns stored in another system, external to the online system 100. The sponsored content selection module 280 examines criteria associated with each sponsored content campaign (e.g., targeting criteria) and selects one or more sponsored content items for presentation to the user. To select the sponsored content, as one example, the sponsored content selection module 280 identifies sponsored content that target a particular user, and perform an auction for placement in the slot based on the expected value of each sponsored content item for placement in the slot.

The performance outcome score generator 270 determines the efficacy of sponsored content slots containing sponsored content presented by a content publisher 140 compared to those placed within the online system 100 or another location that serves as a benchmark placement. For example, the online system 100 may present sponsored content in portions of a newsfeed or a portion of the page on the online system 100. To evaluate the sponsored content slot of a publisher, the performance outcome score generator 270 identifies sponsored content that was selected for presentation at both the benchmark (e.g., the online system 100) and the a content publisher 140 page and the online system 100. The performance outcome score generator 270 determines conversion rate metrics associated with both locations and generates a performance outcome score. This performance outcome score can be used by content publishers 140 to determine the optimal placement of individual sponsored content slots within the layout of a page as well as the overall layout of sponsored content slots in relation to one another in a series of pages. The layout of sponsored content slots may also be termed “page layout flow.”.

The performance outcome score generator 270 generates a performance outcome score used to define the efficacy of sponsored content slots within a content publisher 140. This efficacy is gauged by sponsored content conversion rate metrics that contribute to the overall performance outcome score for a given sponsored content slot. Each sponsored content slot may receive its own performance outcome score based on a benchmark placement within the online system 100

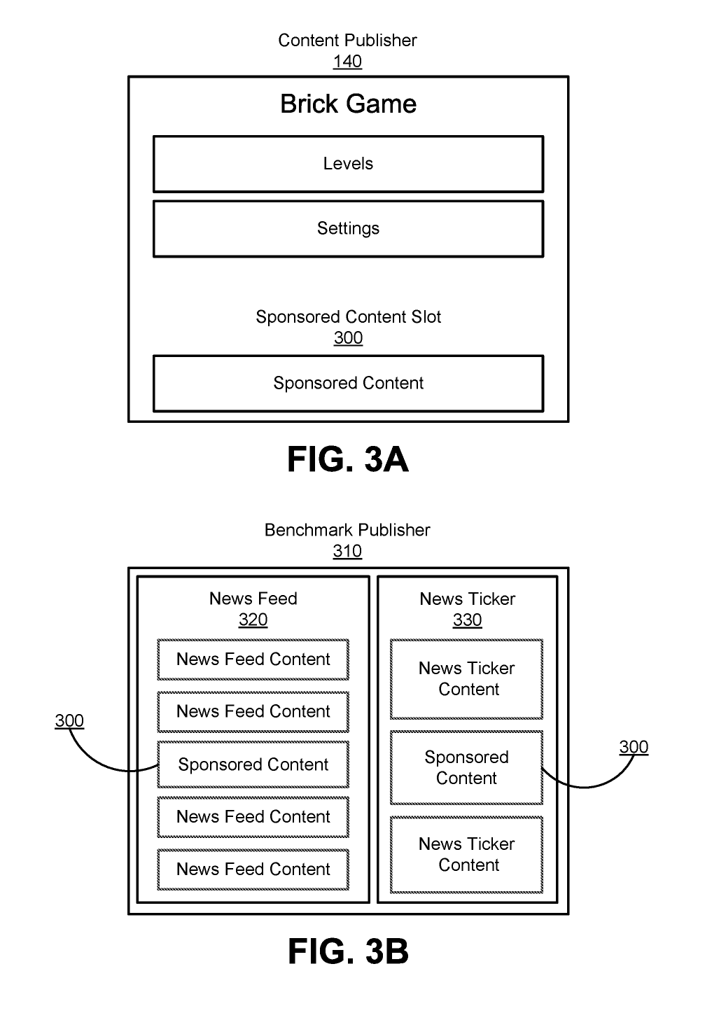

The performance outcome score generation is based on a comparison between conversion rate metrics yielded from sponsored content slots featured in the online system 100 against those produced on a content publisher 140. FIG. 3A provides an example of a sponsored content slot 300 featured on a content publisher 140. FIG. 3B illustrates an example placement of sponsored content slots 300 within the news feed 310 and news ticker 320 presented by the online system 100. To compare conversion rate metrics generated by the sponsored content slot 300 featured on the content publisher 140 against those generated by the slots in the online system 100, sponsored content placed in both locations is kept identical (i.e., same sponsored content campaign). Responsive to loading a content publisher 140 page containing sponsored content slots, the content publisher 140 (or the publisher's application on the client device) sends a sponsored content request to the online system 100 to receive sponsored content to place within the sponsored content slot 300 for presentation to the user. As discussed above, the sponsored content selection module 280 examines available content campaigns, and makes a selection based on criteria associated with each campaign.

As discussed above, each sponsored content campaign affiliated with a third party system 130 may contain criteria regarding when and how to present the sponsored content to users. In one embodiment, criteria affiliated with sponsored content campaigns are stored with the sponsored content in the content store 260 in the online system 100. In other embodiments, these criteria may be stored in a separate system to be used by the online system 100 when needed. Sponsored content campaign criteria may specify: a third party contribution amount (e.g., a value associated with placing the content or a conversion event), targeting criteria, sponsored content type, the objective of the sponsored content (i.e., a conversion event), sponsored content slot type, and a threshold performance outcome score (i.e., threshold publisher conversion rate).

The third party contribution amount is associated with sponsored content provided by a third party system 130 and specifies an amount of compensation the third party system 130 provides the online system 100 if the sponsored content is presented to a user or accessed by a user. The contribution amount may alternatively (or in addition) specify an amount when a user performs a conversion event. In one embodiment, the third party contribution amount is used by the online system 100 to determine an expected value, such as monetary compensation, received by the online system 100 for presenting the content to a user, if the content receives a user interaction, or based on any other suitable condition. For example, the third party contribution amount specifies a monetary amount that the online system 100 receives from the third party system 130 if the conversion event occurs and the expected value is determined based on the third party contribution amount and a probability of a user performing the conversion event.

Targeting criteria describe a target group comprised of specific users of online system 100 users. Targeting is generalized based on user characteristics as determined by the characteristics of a subset of users of the online system 100. Characteristics may include demographic information about users of the online system 100, such as age, gender, political views, education status, college year, relationship status, gender(s) interested in dating, and geographic region information. Thus, the target group may be identified in advance as a list of users, or the target group may be identified as a statement of characteristics or targeting criteria for those users, and the sponsored content selection module 280 may determine at impression time, when an opportunity to provide an impression to a user presents itself, whether that user falls in the target group or not. In other words, the target group may be a list of identifiers in the online system 100 of particular users who have been determined in advance to meet the targeting criteria, or the target group may simply be identified as the targeting criteria itself and the users falling within the targeting criteria may be identified at impression time.

Sponsored content type indicates to the sponsored content selection module 280 which category of sponsored content is to be presented in a sponsored content campaign. The sponsored content type may be used to determine a conversion event or objective for the sponsored content. Examples of sponsored content types include mobile app install ads (MAIA) with purchase events, MAIA with activation events only, MAIA with no events, mobile app engagement, and website conversion. Examples of objectives associated with these sponsored content types include purchase events, activations, installs, app events, and deep funnel conversion, respectively. As discussed above, these conversion events may be identified for each sponsored content, even when the contribution amount is not contingent on the conversion event. Objectives are fulfilled when an online system 100 user completes the action specified by the sponsored content type.

Sponsored content may also specify criteria for types of slots in which sponsored content is to be placed. The sponsored content slots may be of different dimensions and vary proportions, each of which may be suitable for different types of sponsored content. For example, a landing page of a content publisher 140 may specify a banner-size sponsored content slot 300 as shown in FIG. 3A. Additional examples of sponsored content slot types and their respective placements include: banner slots presenting sponsored content on the top or bottom of a page or screen; interstitial slots presenting sponsored content between portions of publisher content, such as on a loading page or a popup window; and sidebar slots presenting sponsored content on the side of a display. As discussed herein, these slots may be evaluated to identify an advertiser outcome score for the slot.

A sponsored content campaign may also specify a threshold performance outcome score that limits presentation of the sponsored content to with a baseline efficacy for sponsored content slot placement on which the third party system 130 is willing to place a third party contribution. For example, if a content publisher 140 page features sponsored content slots that exhibit sufficiently lower conversion rate metrics than those in a benchmark system (e.g., the online system 100) while displaying similar (or the same) sponsored content, a third party system 130 may not wish to place a third party contribution for presentation on that particular page. Conversely, if a content publisher 140 page produces greater conversion rate metrics than those generated by the online system 100, the third party system 130 may decide to place a third party contribution on the content publisher 140 sponsored content slots for the presentation of their sponsored content. In this way, the conversion rate metrics generated by the sponsored content slots within the online system 100 serve as a benchmark for the conversion rate metrics produced by content publishers 140 external to the online system 100 and may be used to control which slots are eligible to receive certain sponsored content.

The performance outcome score generator 270 can use information from the online system 100 to generate sponsored content conversion rate metrics affiliated with individual sponsored content slots displayed on a content publisher 140. In one embodiment, the performance outcome score generator 270 can use information about an online system 100 user collected by the action logger 210, stored in the action log 220, to identify actions taken by the online system 100 user while (and after) interacting with third party sponsored content. For example, a content publisher 140 may recognize a user of an online system 100 through a social plug-in enabling the content publisher 140 to identify the user of the online system 100. Content publishers 140 and other systems accessed by the client device 110 may communicate information about a user's actions outside of the online system 100 to the online system 100 for association with the user. Hence, the action log 220 may record information about actions users perform on other systems to determine when a user performs a conversion event and associate the conversion event with the user who viewed sponsored content on the client device.

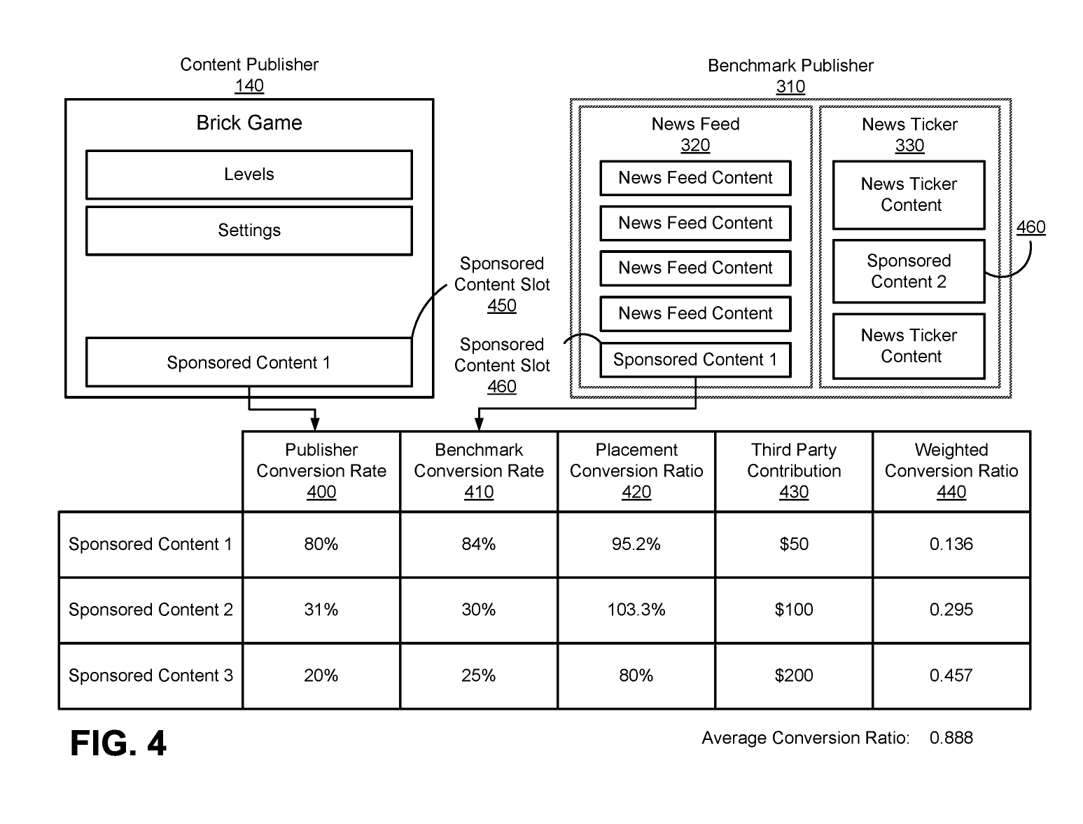

FIG. 4 provides an example use case in which the performance outcome score generator 270 generates a performance outcome score for a sponsored content slot 450 featured on a content publisher 140. In this example, the content publisher provides an application executing on the client device that retrieves and presents sponsored content to the user as the user interacts with the application, for example in a “brick game.” To determine the performance outcome score, sponsored content campaigns are evaluated with respect to the conversion rates for that sponsored content campaign at the sponsored content slot 450 and at the sponsored content slot 460 of the benchmark publisher 310. The sponsored content presented at both the content publisher 140 and the benchmark publisher 310 may be evaluated to identify a consistent set of sponsored content presented. In this example, three items of sponsored content are illustrated as being presented in both locations, although many more may be evaluated in practice.

To evaluate the sponsored content slot 450 with respect to each publisher, the conversion rate is determined for each item of sponsored content at the sponsored content slot 450 and at the benchmark sponsored content slot 460. Thus, a publisher conversion rate 400 is determined by the performance outcome score generator 270 for each of the three sponsored content campaigns (sponsored content 1, 2, and 3) previously featured within the sponsored content slot 400 on the content publisher 140. In addition, the performance outcome score generator 270 determines a benchmark conversion rate 410 for each sponsored content presented in sponsored content slot 460, for example located within the news feed 320 or news ticker 330 of the benchmark publisher 310 for the same three sponsored content campaigns. The conversion rate may be determined by determining the percentage, or rate, of users presented with the sponsored content that later performed the objective or conversion event associated with the sponsored content. The objective or conversion event may be specified by the third party providing the sponsored content, or may be determined based on a type of the sponsored content or other events tracked in relation to the sponsored content (e.g., activation events of an application). Thus, each item of sponsored content may have an associated conversion event that may differ by event type with other evaluated sponsored content. For example, the conversion rate for sponsored content 1 may be based on user interactions with an installed application, while the conversion rate for sponsored content 2 may be based on a user purchase at a webpage.

Conversion rate metrics generated by the content publisher 140 and those from the benchmark publisher 310 are used to determine a placement conversion ratio 420. For example, the performance outcome score generator 270 uses publisher conversion rate 400 metrics for sponsored content 1 (80%) against benchmark conversion rate 410 metrics for the same sponsored content 1 (84%) to produce a placement conversion ratio 420 (95.2%). This placement conversion ratio 420 is the quotient produced by the publisher conversion rate 400 (dividend) and benchmark conversion rate 410 (divisor):

$$placement conversion ratio = \frac{publisher conversion rate}{benchmark conversion rate} = \frac{80 \%}{84 \%} = 95.2 \%$$

The performance outcome score generator 270 uses information from the content store 260 to determine a third party contribution 430 put forth by the third party system 130 that provided sponsored content 1. The contribution may reflect the total amount of contribution by the third party of sponsored content 1 for presenting the sponsored content to users. This contribution ($50), as well as the third party contribution 430 values for sponsored content 2 and 3, is used to weight the placement conversion ratio 420, producing a weighted conversion ratio 440 (0.136) for sponsored content 1:

$$weighted conversion ratio = \frac{95.2 \times third party contribution}{total third party contribution} = \frac{95.2 \times 50}{350} = 0.136$$

The performance outcome score generator 270 combines weighted conversion ratios 440 produced for all three sponsored content campaigns (0.136, 0.295, and 0.457) to yield an average conversion ratio of 0.888. Thus, the placement conversion ratio may be weighed according to the contribution amounts. This value is used to determine the performance outcome score for the sponsored content slot 300 featured on the content publisher 140:

average conversion ratio=0.136+0.295+0.457=0.888

In some examples, the performance outcome store is the average conversion ratio of the sponsored content, while in other examples the performance outcome store is further weighted based on the third party contribution associated with each sponsored content. In additional examples, the performance outcome store is converted from the ratio to a positive numerical value that logarithmically increases. For example, one embodiment of the performance outcome store is:

performance outcome score=min(log₂(0.888)+7,1)=6.83

The performance outcome score may be used for a variety of purposes. As discussed previously, the performance outcome score may be used by a sponsored content provider as criteria for displaying sponsored content, such that sponsored content is not be presented if the performance outcome store does not exceed a certain threshold. In addition, the score may be reported to the content publisher 140 for further analysis and testing (e.g., AB testing) to determine methods for improving the performance outcome score of the content presented by the content publisher 140. As discussed below, the content publisher 140 may modify the location, number, or sequence of sponsored content slots to increase the performance outcome score. The performance outcome score may be generated and provided to a content publisher 140 to identify comparatively low-performing content slots, which the content publisher may use to remove sponsored content slots that do not result in effective user interactions or lead to conversion events (compared to the conversion event frequency of the same sponsored content at the benchmark system).

Using the performance outcome scores, the publisher may evaluate slots within a layout of slots, or within a “flow” of the publisher's application. Thus, the placements of slots relative to one another within the composition of one or more pages of a content publisher 140 can be evaluated with the performance outcome score. This allows the content publisher 140 to compare separate sponsored content placement and page layout flows. For example, if the content publisher 140 replaces an interstitial slot with a banner slot, the flow based performance outcome score may change to yield a higher publisher conversion rate 400.

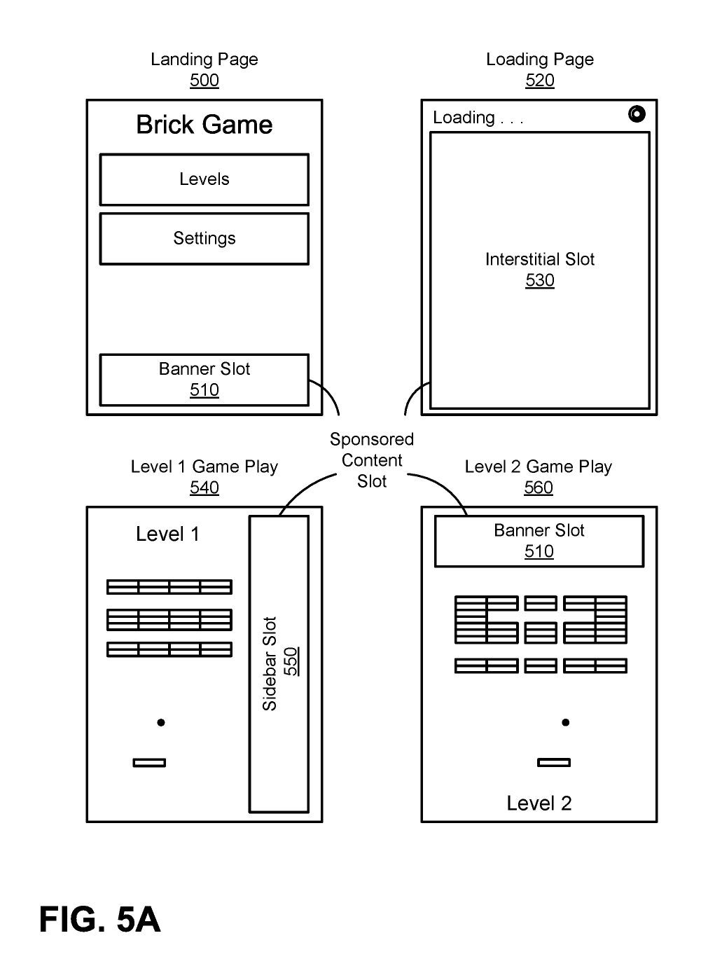

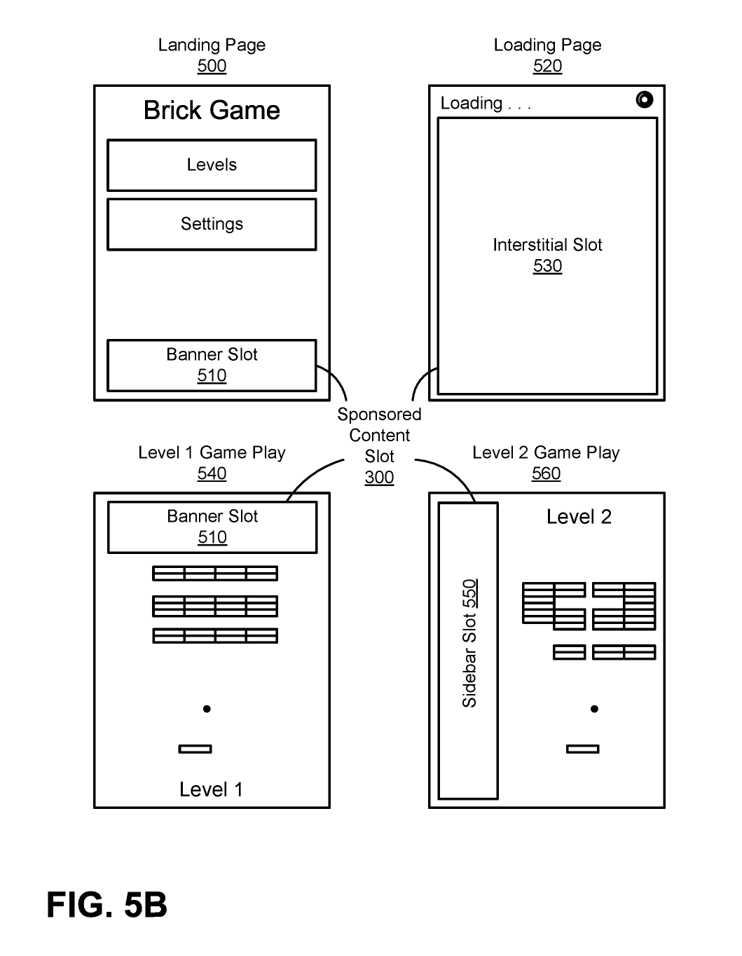

FIG. 5A illustrates an example content publisher 140 page layout flow of a game application, Brick Game. In this example, the landing page 500 contains a banner slot 510, the loading page 520 features an interstitial slot, the first level of game play displays a sidebar slot 550, and the second level of game play contains an additional banner slot 510. The banner slot 510 located on the landing page 500 is filled with sponsored content provided by the online system 100 when an online system 100 user requests to load the page (e.g., open the game application from a client device 110). The interstitial slot 530 is filled when the game application advances from the landing page 500 to the loading page 520 as it begins loading the next state of the game application (e.g., loading level 1 for user game play). The sidebar slot 550 is filled and presented to the online system 100 user during actual level 1 game play 540 within the right portion of the user's screen. Sponsored content that fills the sidebar slot 550 is presented throughout level 1 game play 540. The additional banner slot 510 is filled with sponsored content and presented when the online system 100 user advances to level 2 game play 560 within the top portion of the user's screen. Similar to sponsored content presented in the sidebar slot 550, sponsored content that fills the banner slot 510 is presented throughout level 2 game play 560. Thus, these slots within the advertisement may present a set of slots that may be evaluated with a performance outcome score. Each slot illustrated in FIG. 5A is assigned a performance outcome score by the performance outcome score generator 270 as described above. However, in order to identify how sponsored content slots 300 perform in relation to one another (e.g., different placements within the page layout), the content publisher 140 may elect to implement further testing and analysis to manipulate page layout flow to yield optimal publisher conversion rate 400 metrics.

FIG. 5B illustrates an example manipulation of page layout flow in which the same content publisher 140, Brick Game, has altered the sponsored content slot types and placements level 1 game play 540 and level 2 game play 560 based on performance outcome scores. In relation to FIG. 5A, the sidebar slot 550 from level 1 game play 540 has been replaced with a banner slot 510 to be filled with sponsored content before the user interacts with the level. In addition, the banner slot 510 featured in level 2 game play 560 in FIG. 5A has been replaced with a sidebar slot 550 in FIG. 5B. Further page layout flow manipulation is shown in FIG. 5B as the placement of the sidebar slot 550 relative to general game play has been moved from the right portion of the user's screen in FIG. 5A to the left portion. These changes affect the way that sponsored content is presented to an online system 100 user interacting with the content publisher 140, and, resultantly, affect flow based outcome score. Thus, the performance outcome scores for the set of sponsored content slots permits the application publisher to effectively evaluate alternative flows and slot placements within the application. Because the slots are compared to the benchmark and the comparison for a given slot is based on the content presented in the publisher's slot and in the benchmark placement, the effectiveness of each slot may be more directly compared relative to comparing the raw conversion rates of the slots against one another, in which case the content presented at each slot may vary along with the particular content presented in each slot.

### III. Performance Outcome Score Process

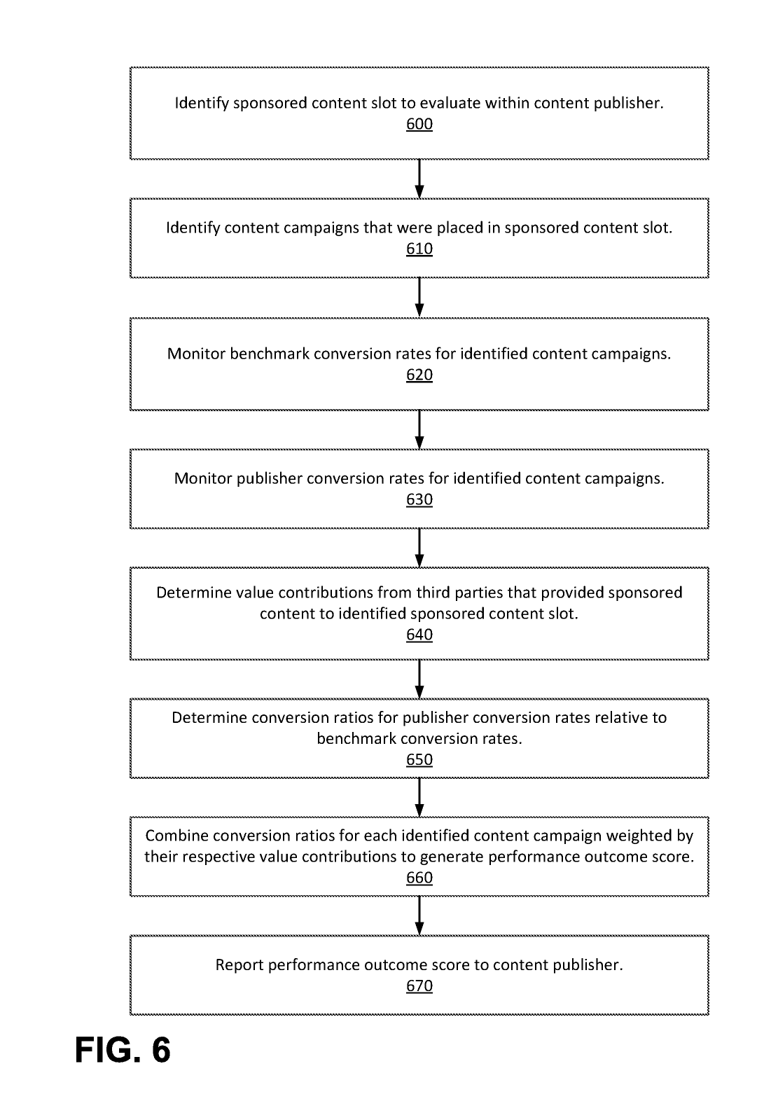

FIG. 6 is a flowchart illustrating a process for generating a performance outcome score for a given sponsored content slot according to one embodiment. In the embodiment illustrated in FIG. 6, the performance outcome score generator 270 identifies 600 a sponsored content slot 300 displayed within a content publisher 140 for evaluation. The performance outcome score generator 270 identifies 610 sponsored content campaigns that were selected by the sponsored content selection module 280 for presentation within the sponsored content slot 300 from those campaigns stored in the content store 260. The performance outcome score generator 270 monitors 620 benchmark conversion rate 410 metrics generated by sponsored content slots 300 placed in within a benchmark placement (e.g., the online system 100) for the identified sponsored content campaigns. In addition, the performance outcome score generator 270 monitors 630 publisher conversion rate 400 metrics produced by sponsored content slots 300 placed within one or more pages of a content publisher 140. The performance outcome score generator 270 determines 640 the third party contribution 430 amount associated with each of the sponsored content campaigns selected for presentation within the sponsored content slot 300. It also determines 650 placement conversion ratios 420 for each of the selected sponsored content campaigns that compare publisher conversion rate 400 metrics to benchmark conversion rate 410 metrics. The performance outcome score generator 270 combines 660 placement conversion ratios 420, each weighted by its respective third party contribution 430, to produce an overall performance outcome score for the identified sponsored content slot. This performance outcome score is reported 670 to the content publisher 140 for changes in page layout flow as needed.

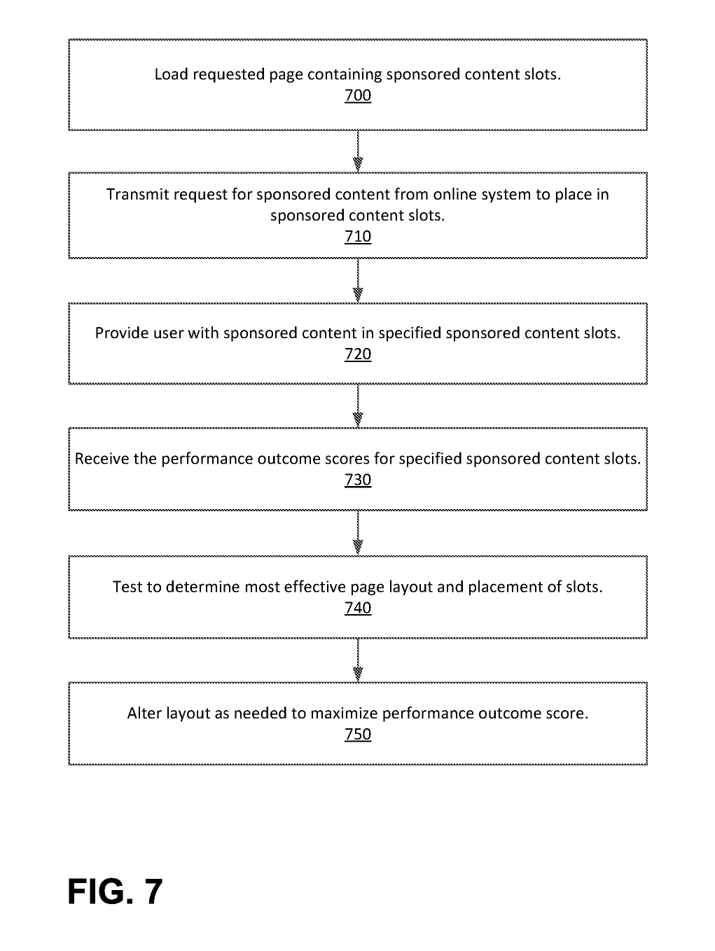

FIG. 7 is a flowchart illustrating a process for providing sponsored content to users of a content publisher 140 according to one embodiment. The content publisher 140 loads 700 a user requested page containing sponsored content slots 300 and transmits 710 a request to the sponsored content selection module 280 for sponsored content from the online system 100 to place within specified sponsored content slots 300 for presentation to the user. The content publisher 140 provides 720 the user with sponsored content placed within the specified sponsored content slots 300, and receives 730 performance outcome scores for those sponsored content slots 300 from the online system 100. It uses the performance outcome scores to test 740 page layout to determine the most efficient sponsored content slot 300 arrangement to garner the greatest publisher conversion rate 400 metrics. The content publisher 140 can then alter 750 page layout to accommodate an optimal page layout flow for maximizing publisher conversion rate 400 metrics.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying a sponsored content slot within a content publisher for evaluation of relative efficacy of the sponsored content slot relative to a benchmark placement, wherein an online system selects content items for placement in the sponsored content slot responsive to individual requests for content from client devices interacting with the content publisher;
identifying a plurality of sponsored content items previously selected for placement within the sponsored content slot;
for each of the plurality of sponsored content items, determining a conversion ratio of a placement rate of desired user interaction with the sponsored content item when the content item is placed at the sponsored content slot compared to a benchmark rate of desired user interaction with the sponsored content item when the content item is placed at a benchmark placement;
determining a performance outcome score associated with the sponsored content slot by combining the plurality of conversion ratios; and
sending the performance outcome score associated with the sponsored content slot to the content publisher.

2. The computer-implemented method of claim 1, further comprising:
determining a third-party contribution associated with each of the plurality of sponsored content items, the third party contribution representing a value provided by a third party for placing the sponsored content in the sponsored content slot; and wherein combining the plurality of conversion ratios to determine the performance outcome score includes weighing the conversion ratios according to the respective value provided by the third party.

3. The computer-implemented method of claim 1, wherein the desired user action for a first sponsored content item differs from the desired user action for a second sponsored content item.

4. The computer-implemented method of claim 1, wherein the conversion ratio for a sponsored content item is determined for a look-back period of placing the sponsored content items.

5. The computer-implemented method of claim 4, wherein the look-back period for a sponsored content item based on a volume of placements of the sponsored content item.

6. The computer-implemented method of claim 4, wherein the look-back period for a first sponsored content item differs from the look-back period for a second sponsored content item.

7. The computer-implemented method of claim 1, wherein the benchmark placement corresponds to placement within sponsored content slots within another online system.

8. The computer-implemented method of claim 1, wherein the benchmark placement is a previous placement location of the sponsored content slot within the content publisher.

9. The computer-implemented method of claim 1, further comprising:
receiving a request for a content item for placement in the sponsored content slot for display to a user; and
identifying a set of sponsored content items eligible for display to the user;
identifying a subset of sponsored content items from the set of sponsored content items based on the performance outcome score of the sponsored content slot;
selecting a sponsored content item for placement in the sponsored content slot from the subset of sponsored content items; and
sending the selected sponsored content item for display to the user in the sponsored content slot.

10. The computer-implemented method claim 1, wherein the sponsored content slot is one of a plurality of sponsored content slots in a first set of sponsored content slots presented in a first application flow of an application of a client device, the method further comprising:
determining a first application performance outcome score for the first set of sponsored content slots, based in part on the performance outcome score for the sponsored content slot;
determining a second application performance outcome score for a second set of sponsored content slots for a second application flow of the application; and
determining a preferred application flow from the first application flow and the second application flow based on the first application performance outcome score and the second application performance outcome score.

11. A non-transitory computer readable storage medium having instructions encoded thereon that, when executed by a processor, cause the processor to perform the steps including:
identifying a sponsored content slot within a content publisher for evaluation of relative efficacy of the sponsored content slot relative to a benchmark placement, wherein an online system selects content items for placement in the sponsored content slot responsive to individual requests for content from client devices interacting with the content publisher;
identifying a plurality of sponsored content items previously selected for placement within the sponsored content slot;
for each of the plurality of sponsored content items, determining a conversion ratio of a placement rate of desired user interaction with the sponsored content item when the content item is placed at the sponsored content slot compared to a benchmark rate of desired user interaction with the sponsored content item when the content item is placed at a benchmark placement;
determining a performance outcome score associated with the sponsored content slot by combining the plurality of conversion ratios; and
sending the performance outcome score associated with the sponsored content slot to the content publisher.

12. The non-transitory computer readable storage medium of claim 1, further comprising:
determining a third-party contribution associated with each of the plurality of sponsored content items, the third party contribution representing a value provided by a third party for placing the sponsored content in the sponsored content slot; and wherein combining the plurality of conversion ratios to determine the performance outcome score includes weighing the conversion ratios according to the respective value provided by the third party.

13. The non-transitory computer readable storage medium of claim 1, wherein the desired user action for a first sponsored content item differs from the desired user action for a second sponsored content item.

14. The non-transitory computer readable storage medium of claim 1, wherein the conversion ratio for a sponsored content item is determined for a look-back period of placing the sponsored content items.

15. The non-transitory computer readable storage medium of claim 4, wherein the look-back period for a sponsored content item based on a volume of placements of the sponsored content item.

16. The non-transitory computer readable storage medium of claim 4, wherein the look-back period for a first sponsored content item differs from the look-back period for a second sponsored content item.

17. The non-transitory computer readable storage medium of claim 1, wherein the benchmark placement corresponds to placement within sponsored content slots within another online system.

18. The non-transitory computer readable storage medium of claim 1, wherein the benchmark placement is a previous placement location of the sponsored content slot within the content publisher.

19. The non-transitory computer readable storage medium of claim 1, further comprising:
receiving a request for a content item for placement in the sponsored content slot for display to a user; and
identifying a set of sponsored content items eligible for display to the user;
identifying a subset of sponsored content items from the set of sponsored content items based on the performance outcome score of the sponsored content slot;
selecting a sponsored content item for placement in the sponsored content slot from the subset of sponsored content items; and
sending the selected sponsored content item for display to the user in the sponsored content slot.

20. The non-transitory computer readable storage medium claim 1, wherein the sponsored content slot is one of a plurality of sponsored content slots in a first set of sponsored content slots presented in a first application flow of an application of a client device, the method further comprising:
determining a first application performance outcome score for the first set of sponsored content slots, based in part on the performance outcome score for the sponsored content slot;
determining a second application performance outcome score for a second set of sponsored content slots for a second application flow of the application; and
determining a preferred application flow from the first application flow and the second application flow based on the first application performance outcome score and the second application performance outcome score.
